(19) United States
(12) Patent Application Publication
(10) Pub. No.: US 2021/0018048 A1
(43) Pub. Date: Jan. 21, 2021

(54) IMPACT STRUCTURE

(71) Applicant: Best Achieve Industrial Limited Dongguan City (CN), Dongguan (CN)

(72) Inventors: Shuang-qun Li, Dongguan (CN); Hsi-Jen Jen, Dongguan (CN); Xiang-kui Li, Dongguan (CN)

(21) Appl. No.: 16/903,966

(22) Filed: Jun. 17, 2020

(30) Foreign Application Priority Data
Jul. 19, 2019 (CN) 2019106477568

(51) Int. Cl. F16D 13/56; F16D 13/71

(52) U.S. Cl. CPC F16D 13/56; F16D 13/71

(57) ABSTRACT

An improved impact structure comprising a transmission shaft, an impact disc, a driving disc, an output shaft and an impact spring, wherein the driving disc is cylindrical, a lower surface of the driving disc is provided with two V-shaped first inclined surfaces arranged symmetrically. Two V-shaped second inclined surfaces matched with the first inclined surfaces are symmetrically arranged in the middle hole of the impact disc. An output end of the transmission shaft penetrates through the impact disc and is movably connected to the output shaft. One end of the output shaft and an upper end surface of the impact disc are circumferentially provided with a first and a second impact block. One end of the impact spring extends into the inner cavity of the impact disc. Through adopting the present disclosure, the transmission shaft without V-shaped grooves has a higher strength, and qualification rate is significantly improved.

### TECHNICAL FIELD

This disclosure generally relates to the technical field of electric screwdrivers, and more particularly, to an improved impact structure.

### BACKGROUND

An electric screwdriver is a commonly used hand-held tool. There are various electric screwdrivers sold on the market. FIG. 8 shows a conventional electric screwdriver having an impact structure, wherein the impact structure typically includes a transmission shaft 101, an impact disc 102, an output shaft 103, and an impact spring 104. The two sides of the middle portion of the transmission shaft 101 are symmetrically provided with inclined grooves 1012 whose cross-section is V-shaped, and the two sides of the inner cavity wall of the impact disc 102 are symmetrically provided with protrusions matched with the inclined grooves 1012. One end of the output shaft 103 is circumferentially provided with a first impact block 1031, and the upper end surface of the impact disc 102 is circumferentially provided with a second impact block 1021. Its operating principle is: the impact disc 102 is connected to the transmission shaft 101 through steel balls 105. When the transmission shaft 101 rotates, the impact disc 102 is propelled to rotate through the steel balls 105. At this point, the second impact block 1021 on the impact disc 102 strikes the first impact block 1031 on the output shaft 103 to realize an impact. The transmission shaft 101 continues rotating, and the impact disc 102 moves downwards along the inclined grooves 1012 of the transmission shaft 101. When the upper end surface of the second impact block 1021 is disengaged from the lower end surface of the output shaft 103, the impact disc 102 is reset immediately under the action of the impact spring 104, thereby achieving a next impact.

In the aforesaid structure, due to the protrusions arranged on the inner cavity wall of the impact disc 102 and the inclined grooves 1012 formed in the two sides of the middle portion of the transmission shaft 101, the manufacturing process is complicated, and the manufacturing cost is high. Even worse, after the inclined grooves 1012 are formed in the two sides of the transmission shaft 101, the strength of the transmission shaft 101 is reduced, and the functional life of the transmission shaft 101 is shortened.

### SUMMARY

The purpose of the present disclosure is to provide an improved impact structure.

To achieve the above purpose, the present disclosure adopts the following technical solution: an improved impact structure comprising a transmission shaft, an impact disc, a driving disc, an output shaft and an impact spring, wherein the driving disc is cylindrical, the lower surface of the driving disc is provided with two first inclined surfaces arranged symmetrically, and the two first inclined surfaces are configured to be V-shaped, wherein two second inclined surfaces matched with the first inclined surfaces are arranged in the middle hole of the impact disc, wherein the two second inclined surfaces are symmetrically arranged, and the cross section of the second inclined surfaces is configured to be V-shaped, wherein the output end of the transmission shaft penetrates through the impact disc, and is movably connected to the output shaft, wherein the driving disc is fixedly mounted on the transmission shaft, and is arranged in the middle hole of the impact disc, wherein the first inclined surface is in contact with the second inclined surface, wherein one end of the output shaft, which is close to the impact disc, is circumferentially provided with a first impact block, and the upper end surface of the impact disc is circumferentially provided with a second impact block, wherein one end of the impact spring extends into the inner cavity of the impact disc, and the other end of the impact spring abuts against a limiting step of the transmission shaft.

In another aspect of the present disclosure, the included angles between the two planes of the first inclined surfaces and the horizontal plane are acute angles.

In another aspect of the present disclosure, the included angles between the two planes of the second inclined surfaces and the horizontal plane are acute angles.

In another aspect of the present disclosure, the transmission shaft is provided with first key grooves, and the inner wall of the driving disc is provided with two opposite second key grooves. Steel balls are arranged between the first key grooves and the second key grooves. The driving disc is connected to the transmission shaft through the steel balls, the first key grooves, and the second key grooves.

In another aspect of the present disclosure, the impact disc is provided with a through hole for allowing the transmission shaft to pass through. The upper half of the through hole is provided with a middle hole coaxial with the through hole, and the diameter of the middle hole is greater than that of the through hole. The two second inclined surfaces are symmetrically arranged in an annular groove formed by the middle hole and the through hole.

In another aspect of the present disclosure, the upper portion of the driving disc is provided with a ratchet wheel, and the upper surface of the driving disc is provided with ratchet teeth matched with the ratchet wheel. The ratchet wheel is mounted at an end portion of the output shaft, and is engaged with the ratchet teeth of the driving disc.

In another aspect of the present disclosure, the lower portion of the through hole in the impact disc is provided with a positioning hole coaxial with the through hole, the diameter of the positioning hole is greater than that of the through hole, and one end of the impact spring extends into the positioning hole.

In another aspect of the present disclosure, the bottom of the positioning hole is provided with a circle of steel balls arranged around the outer circumferential wall of the through hole. A first gasket is arranged between the steel balls and the upper end portion of the impact spring, and the first gasket is sleeved on the outer circumferential wall of the through hole.

In another aspect of the present disclosure, a second gasket is arranged between the limiting step of the transmission shaft and the lower end portion of the impact spring, and the second gasket is connected to the transmission shaft in a sleeving mode.

As the inclined grooves are formed in the driving disc instead of the transmission shaft, the manufacturing cost is reduced, the labor is saved, and the mass production is realized. Moreover, the transmission shaft without V-shaped grooves has a higher strength, and the qualification rate is significantly improved.

### BRIEF DESCRIPTION OF THE DRAWINGS

FIG. 1 is a conceptual diagram illustrating an example structure of the impact structure of embodiment 1.

FIG. 2 is a conceptual diagram illustrating a sectional view of the impact structure shown in FIG. 1.

FIG. 3 is a conceptual diagram illustrating an explosive view of the impact structure of embodiment 1.

FIG. 4 is a conceptual diagram illustrating a sectional view of the impact structure of embodiment 2.

FIG. 5 is a conceptual diagram illustrating an explosive view of the impact structure of embodiment 2.

FIG. 6 is a conceptual diagram illustrating an example structure of the driving disc of the present disclosure.

FIG. 7 is a conceptual diagram illustrating an example structure of the impact disc of the present disclosure.

FIG. 8 is a conceptual diagram illustrating a structure of a conventional impact structure.

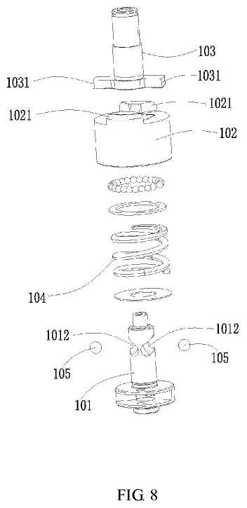

### DETAILED DESCRIPTION

Figures and detailed embodiments are combined hereinafter to clearly and completely describe the technical solution of the present disclosure. Obviously, the described embodiments are merely a part but not all of the embodiments of the present disclosure. The specification of the present disclosure may allow those skilled in the art to obtain other embodiments without paying creative labor, and thus all of which shall fall into the scope of the present disclosure.

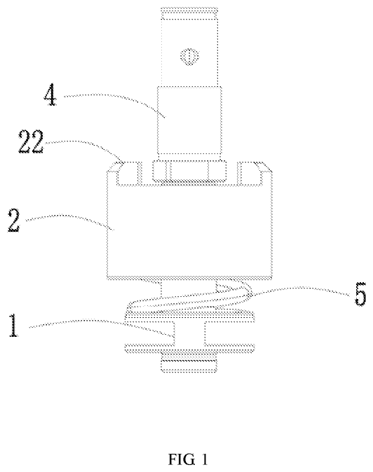

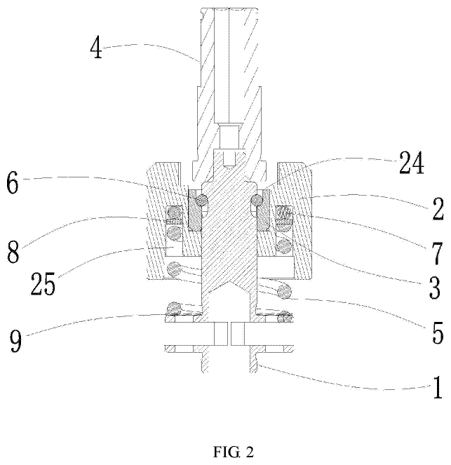

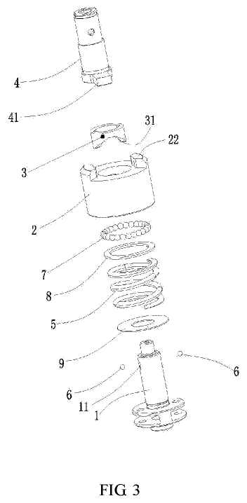

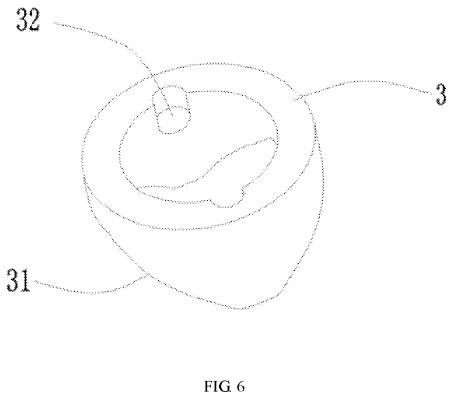

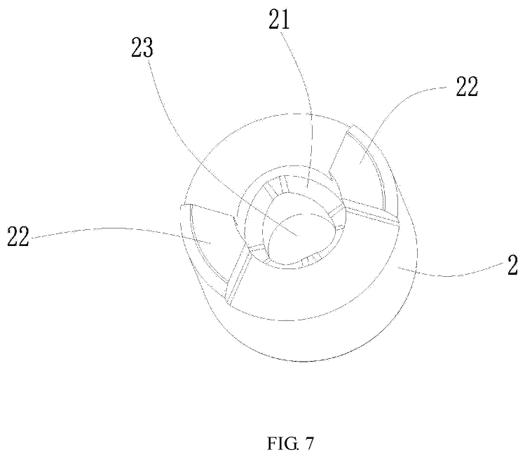

As shown in FIGS. 1-3, 6 and 7, in embodiment 1, the improved impact structure comprises a transmission shaft 1, an impact disc 2, a driving disc 3, an output shaft 4 and an impact spring 5. The driving disc 3 is cylindrical, wherein the lower surface of the driving disc 3 is provided with two first inclined surfaces 31 arranged symmetrically, and the two first inclined surfaces 31 are configured to be V-shaped. Two second inclined surfaces 21 matched with the first inclined surfaces 31 are arranged in the middle hole of the impact disc 2, wherein the two second inclined surfaces 21 are symmetrically arranged, and the cross section of the second inclined surfaces 21 is configured to be V-shaped. The output end of the transmission shaft 1 penetrates through the impact disc 2 and is movably connected to the output shaft 4. The driving disc 3 is fixedly mounted on the transmission shaft 1 and is arranged in the middle hole of the impact disc 2. The first inclined surface 31 is in contact with the second inclined surface 21. One end of the output shaft 4, which is close to the impact disc 2, is circumferentially provided with a first impact block 41, and the upper end surface of the impact disc 2 is circumferentially provided with a second impact block 22. One end of the impact spring 5 extends into the inner cavity of the impact disc 2, and the other end of the impact spring 5 abuts against a limiting step of the transmission shaft 1.

The included angles between the two planes of the first inclined surfaces 31 and the horizontal plane are acute angles.

The included angles between the two planes of the second inclined surfaces 21 and the horizontal plane are acute angles.

The transmission shaft 1 is provided with first key grooves 11, and the inner wall of the driving disc 3 is provided with two opposite second key grooves 32. Steel balls 6 are arranged between the first key grooves 11 and the second key grooves 32. The driving disc 3 is connected to the transmission shaft 1 through the steel balls 6, the first key grooves 11 and the second key grooves 32.

The impact disc 2 is provided with a through hole 23 for allowing the transmission shaft 1 to pass through. The upper half of the through hole 23 is provided with a middle hole 24 coaxial with the through hole 23, and the diameter of the middle hole 24 is greater than that of the through hole 23. The two second inclined surfaces 21 are symmetrically arranged in an annular groove formed by the middle hole 24 and the through hole 23.

The lower portion of the through hole 23 in the impact disc 2 is provided with a positioning hole 25 coaxial with the through hole 23, the diameter of the positioning hole 25 is greater than that of the through hole 23, and one end of the impact spring 5 extends into the positioning hole 25.

The bottom of the positioning hole 25 is provided with a circle of steel balls 7 arranged around the outer circumferential wall of the through hole 23. A first gasket 8 is arranged between the steel balls 7 and the upper end portion of the impact spring 5, and the first gasket 8 is sleeved on the outer circumferential wall of the through hole 23.

A second gasket 9 is arranged between the limiting step of the transmission shaft 1 and the lower end portion of the impact spring 5, and the second gasket 9 is connected to the transmission shaft 1 in a sleeving mode.

The operating principle of the present disclosure is the following: when the transmission shaft 1 propels the driving disc 3 to rotate, the impact disc 2 rotates along the transmission shaft 1, and the second impact block 22 strikes the first impact block 41, thereby enabling the output shaft 4 to rotate. As the first inclined surfaces 31 of the driving disc 3 interact with the second inclined surfaces 21 of the impact disc 2, the impact disc 2 moves downwards in the axial direction of the transmission shaft 1. When the upper end surface of the second impact block 22 is disengaged from the lower end surface of the first impact block 41, the impact disc 2 moves upwards to reset under the action of the impact spring 5, and the second impact block 22 strikes the first impact block 41 again. Subsequently, the first inclined surfaces 31 of the driving disc 3 interact with the second inclined surfaces 21 of the impact disc 2, which allows the impact disc 2 to move downwards. In this way, the impact disc 2 strikes the first impact block 41 of the output shaft 4 after a certain interval, thus making the output shaft 4 rotate intermittently.

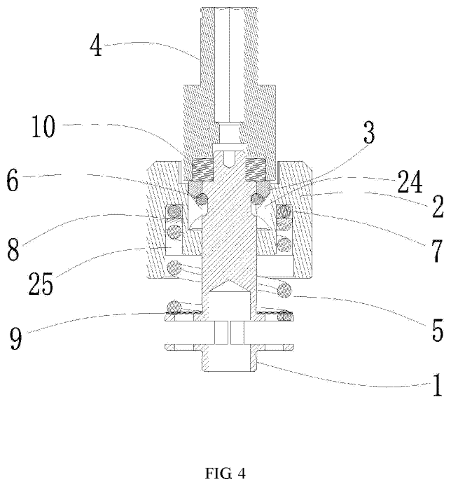

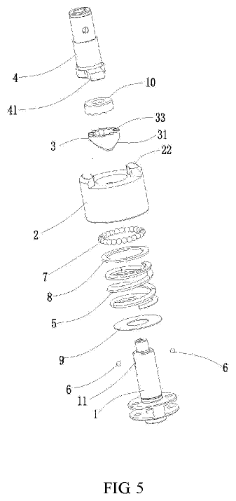

As shown in FIGS. 4-5, in embodiment 2, the improved impact structure comprises a transmission shaft 1, an impact disc 2, a driving disc 3, an output shaft 4 and an impact spring 5. The driving disc 3 is cylindrical, wherein the lower surface of the driving disc 3 is provided with two first inclined surfaces 31 arranged symmetrically, and the two first inclined surfaces 31 are configured to be V-shaped. Two second inclined surfaces 21 matched with the first inclined surfaces 31 are arranged in the middle hole of the impact disc 2, wherein the two second inclined surfaces 21 are symmetrically arranged, and the cross section of the second inclined surfaces 21 is configured to be V-shaped. The output end of the transmission shaft 1 penetrates through the impact disc 2 and is movably connected to the output shaft 4. The driving disc 3 is fixedly mounted on the transmission shaft 1, and is arranged in the middle hole of the impact disc 2. The first inclined surface 31 is in contact with the second inclined surface 21. One end of the output shaft 4, which is close to the impact disc 2, is circumferentially provided with a first impact block 41, and the upper end surface of the impact disc 2 is circumferentially provided with a second impact block 22. One end of the impact spring 5 extends into the inner cavity of the impact disc 2, and the other end of the impact spring 5 abuts against a limiting step of the transmission shaft 1. Further, the upper portion of the driving disc 3 is provided with a ratchet wheel 10, and the upper surface of the driving disc 3 is provided with ratchet teeth 33 matched with the ratchet wheel 10. The ratchet wheel 10 is mounted at an end portion of the output shaft 4, and is engaged with the ratchet teeth 33 of the driving disc 3.

The included angles between the two planes of the first inclined surfaces 31 and the horizontal plane are acute angles.

The included angles between the two planes of the second inclined surfaces 21 and the horizontal plane are acute angles.

The transmission shaft 1 is provided with first key grooves 11, and the inner wall of the driving disc 3 is provided with two opposite second key grooves 32. Steel balls 6 are arranged between the first key grooves 11 and the second key grooves 32. The driving disc 3 is connected to the transmission shaft 1 through the steel balls 6, the first key grooves 11 and the second key grooves 32.

The impact disc 2 is provided with a through hole 23 for allowing the transmission shaft 1 to pass through. The upper half of the through hole 23 is provided with a middle hole 24 coaxial with the through hole 23, and the diameter of the middle hole 24 is greater than that of the through hole 23. The two second inclined surfaces 21 are symmetrically arranged in an annular groove formed by the middle hole 24 and the through hole 23.

The lower portion of the through hole 23 in the impact disc 2 is provided with a positioning hole 25 coaxial with the through hole 23, the diameter of the positioning hole 25 is greater than that of the through hole 23, and one end of the impact spring 5 extends into the positioning hole 25.

The bottom of the positioning hole 25 is provided with a circle of steel balls 7 arranged around the outer circumferential wall of the through hole 23. A first gasket 8 is arranged between the steel balls 7 and the upper end portion of the impact spring 5, and the first gasket 8 is sleeved on the outer circumferential wall of the through hole 23.

A second gasket 9 is arranged between the limiting step of the transmission shaft 1 and the lower end portion of the impact spring 5, and the second gasket 9 is connected to the transmission shaft 1 in a sleeving mode.

The rotation principle of the output shaft 4 in this embodiment is the same as that in embodiment 1. What makes them different is an additional function of the impact structure in embodiment 2. When the driving disc 3 rotates, the driving disc 3 is engaged with or disengaged from the ratchet wheel 10 through the ratchet teeth 33, which enables the output shaft 4 moves axially while rotating. When the impact structure of the present disclosure is applied to an electric screwdriver, the function of axially striking the screw is added to the electric screwdriver.

The aforesaid description is merely used to describe the preferred embodiments of the present disclosure and is not intended to limit the scope of the present disclosure. Any equivalent implementations or modifications without departing from the technical principles of the present disclosure shall fall into the scope of the present disclosure.

What is claimed is:

1. An improved impact structure, comprising:
a transmission shaft,
an impact disc,
a driving disc,
an output shaft, and
an impact spring, wherein the driving disc is cylindrical, a lower surface of the driving disc is provided with two first inclined surfaces arranged symmetrically, and the two first inclined surfaces are configured to be V-shaped, wherein two second inclined surfaces matched with the first inclined surfaces are arranged in a middle hole of the impact disc, wherein the two second inclined surfaces are symmetrically arranged, and a cross section of the second inclined surfaces is configured to be V-shaped, wherein an output end of the transmission shaft penetrates through the impact disc, and is movably connected to the output shaft, wherein the driving disc is fixedly mounted on the transmission shaft, and is arranged in the middle hole of the impact disc, wherein the first inclined surface is in contact with the second inclined surface, wherein one end of the output shaft, which is close to the impact disc, is circumferentially provided with a first impact block, and an upper end surface of the impact disc is circumferentially provided with a second impact block, wherein one end of the impact spring extends into an inner cavity of the impact disc, and another end of the impact spring abuts against a limiting step of the transmission shaft.

2. The improved impact structure of claim 1, wherein included angles between two planes of the first inclined surfaces and horizontal plane are acute angles.

3. The improved impact structure of claim 1, wherein the included angles between two planes of the second inclined surfaces and horizontal plane are acute angles.

4. The improved impact structure of claim 1, wherein the transmission shaft is provided with first key grooves, and the inner wall of the driving disc is provided with two opposite second key grooves, wherein steel balls are arranged between the first key grooves and the second key grooves, wherein the driving disc is connected to the transmission shaft through the steel balls, the first key grooves and the second key grooves.

5. The improved impact structure of claim 1, wherein the impact disc is provided with a through hole for allowing the transmission shaft to pass through, wherein an upper half of the through hole is provided with a middle hole coaxial with the through hole, and a diameter of the middle hole is greater than a diameter of the through hole, wherein the two second inclined surfaces are symmetrically arranged in an annular groove formed by the middle hole and the through hole.

6. The improved impact structure of claim 1, wherein an upper portion of the driving disc is provided with a ratchet wheel, and an upper surface of the driving disc is provided with ratchet teeth matched with the ratchet wheel, wherein the ratchet wheel is mounted at an end portion of the output shaft, and is engaged with the ratchet teeth of the driving disc.

7. The improved impact structure of claim 1, wherein a lower portion of the through hole in the impact disc is provided with a positioning hole coaxial with the through hole, a diameter of the positioning hole is greater than a diameter of the through hole, and one end of the impact spring extends into the positioning hole.

8. The improved impact structure of claim 7, wherein a bottom of the positioning hole is provided with a circle of steel balls arranged around an outer circumferential wall of the through hole, wherein a first gasket is arranged between the steel balls and an upper end portion of the impact spring, and the first gasket is sleeved on the outer circumferential wall of the through hole.

9. The improved impact structure of claim 1, wherein a second gasket is arranged between the limiting step of the transmission shaft and a lower end portion of the impact spring, and the second gasket is connected to the transmission shaft in a sleeving mode.
